(19) United States
(12) Patent Application Publication
(10) Pub. No.: US 2020/0110388 A1
(43) Pub. Date: Apr. 9, 2020

(54) MACHINE TOOL GROUPING DEVICE AND GROUPING METHOD

(71) Applicant: FANUC CORPORATION, Yamanashi (JP)

(72) Inventor: Shohei Takeno, Minamitsuru-gun (JP)

(73) Assignee: FANUC CORPORATION, Yamanashi (JP)

(21) Appl. No.: 16/594,347

(22) Filed: Oct. 7, 2019

(30) Foreign Application Priority Data
Oct. 9, 2018 (JP) 2018-190931

(51) Int. Cl. G05B 19/418

(52) U.S. Cl. CPC G05B 19/4188; G05B 2219/45047; G05B 2219/31001

(57) ABSTRACT

A grouping device includes: an information collecting unit configured to collect machining information about machining operations from a plurality of machine tools; and a grouping unit configured to sort the plurality of machine tools into a plurality of groups based on the collected multiple pieces of machining information.

### CROSS-REFERENCE TO RELATED APPLICATION

This application is based upon and claims the benefit of priority from Japanese Patent Application No. 2018-190931 filed on Oct. 9, 2018, the contents of which are incorporated herein by reference.

### BACKGROUND OF THE INVENTION

### Field of the Invention

The present invention relates to a machine tool grouping device and grouping method.

### Description of the Related Art

Machine tools perform machining operations according to machining programs and parameters indicating machining conditions. In a factory where multiple machine tools are provided, a management device, e.g., disclosed in International Publication No. WO 2017/090098, monitors the multiple machine tools to see whether each machine tool is in operation, based on signals obtained from sensors attached to the multiple machine tools.

### SUMMARY OF THE INVENTION

For such factories as mentioned above, there is a demand to improve efficiency of changing machining programs and changing settings of parameters by grouping machine tools based on whether they have high correlations about machining operations and performing such changing procedure group by group.

Accordingly, an object of the present invention is to provide a grouping device and a grouping method for grouping machine tools that can easily achieve grouping of a plurality of machine tools in such a way that machine tools having a high correlation concerning machining operations are grouped together.

According to a first aspect, a machine tool grouping device includes: an information collecting unit configured to collect machining information about machining operations from a plurality of machine tools; and a grouping unit configured to sort the plurality of machine tools into a plurality of groups based on multiple pieces of the collected machining information.

According to a second aspect, a machine tool grouping method includes: an information collecting step of collecting machining information about machining operations from a plurality of machine tools; and a grouping step of sorting the plurality of machine tools into a plurality of groups based on multiple pieces of the collected machining information.

According to the present invention, machining information about machining operation is collected from each of the plurality of machine tools and the plurality of machine tools are grouped based on the collected machining information. It is thus possible to easily achieve grouping of the plurality of machine tools in such a way that machine tools having a high correlation about machining operations are grouped together.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a system diagram including a grouping device of an embodiment;

FIG. 2 is a block diagram showing a configuration of the grouping device of the embodiment in a simplified manner;

FIG. 3 is a flowchart showing the flow of a process performed by the grouping device of the embodiment in a simplified manner;

FIG. 4 is a table showing an example of machining information collected by an information collecting unit of the embodiment;

FIG. 5 is a table showing an example of group information generated by a grouping unit of the embodiment; and

FIG. 6 is a table showing an example of a correspondence table concerning the degrees of similarity generated by a grouping unit according to a seventh modification.

### DESCRIPTION OF THE PREFERRED EMBODIMENTS

The grouping device and grouping method for grouping machine tools according to the present invention will now be described in detail in conjunction with preferred embodiments while referring to the accompanying drawings.

### Embodiment

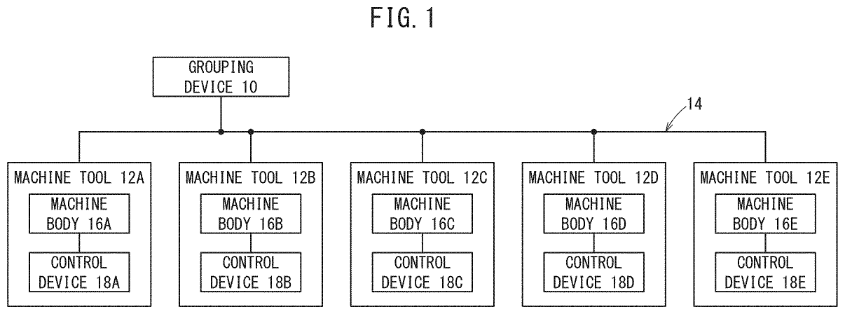

FIG. 1 is a system diagram including a grouping device 10 according to an embodiment.

According to this embodiment, the grouping device 10 and a plurality of machine tools 12 (12A to 12E) are connected through a network 14 such that the grouping device 10 and the plurality of machine tools 12 can send and receive information to and from each other. The network 14 may be wired or wireless.

Each machine tool 12 of this embodiment includes a machine body 16 (16A to 16E) having a spindle to which a tool is attached and a control device 18 (18A to 18E) having a processor and memory. The memory of each control device 18 stores a machining program or programs for performing machining operation with the machine tool 12 and parameters indicating machining conditions. Needless to say, the machining programs and parameter settings can be optionally changed for each machine tool 12. In this embodiment, it is assumed that the machine tools 12A, 12C perform machining operations according to the same machining program and the machine tools 12B, 12D, 12E perform machining operations according to a different machining program from the machine tool 12A.

In each of such machine tools 12 as described above, the machine body 16 is controlled according to a machining program stored in the corresponding control device 18 so as to carry out machining operation. FIG. 1 shows five machine tools 12, but the number of machine tools 12 connected to the grouping device 10 is not limited to five.

The grouping device 10 is a device that is configured to sort the plurality of machine tools 12 into a plurality of groups on the basis of machining information. The term “machining information” means information concerning machining operations performed by the machine tools 12, which can be, for example, a machining program set for each machine tool 12, identification information for identifying the machining program, or parameters set for each machine tool 12. The “identification information” can be a program number or comment assigned to each machining program, for example, which is information stored in the machine tool 12 in association with the machining program. In this embodiment, the program numbers are handled as the machining information, and hereinafter “machining information” means the program numbers unless otherwise specified.

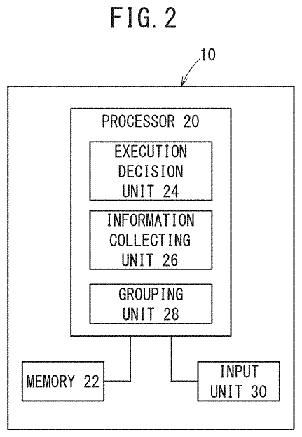

FIG. 2 is a block diagram showing a configuration of the grouping device 10 of this embodiment in a simplified manner.

The grouping device 10 will now be described in further detail. The grouping device 10 of this embodiment includes a processor 20 and a memory 22, and is configured to perform arithmetic operations including execution of programs etc. The processor 20 includes an execution decision unit 24, an information collecting unit 26, and a grouping unit 28. The execution decision unit 24 is a processing unit configured to decide whether to execute the processing of the grouping unit 28 (which will be described later). The information collecting unit 26 is a processing unit configured to collect the machining information from each machine tool 12. The grouping unit 28 is a processing unit configured to sort the plurality of machine tools 12 into a plurality of groups on the basis of the collected multiple pieces of machining information. The execution decision unit 24, information collecting unit 26, and grouping unit 28 execute respective processing according to a given program executed by the processor 20. In addition to the processor 20 and memory 22, the grouping device 10 of this embodiment further includes an input unit 30 configured to allow an operator to change the machining programs and parameter settings of the machine tools 12. The input unit 30 can be a keyboard or a touch panel, for example.

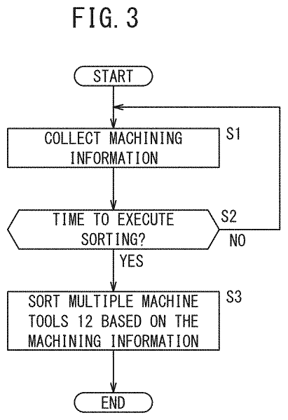

FIG. 3 is a flowchart showing the flow of a process performed by the grouping device 10 of this embodiment in a simplified manner.

Now, referring to FIG. 3, the flow of process performed by the grouping device 10 will be explained. The series of steps shown in FIG. 3 will be hereinafter also referred to collectively as “grouping processing”.

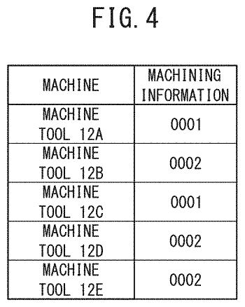

At step S1, the information collecting unit 26 collects the machining information from the plurality of machine tools 12. As shown in FIG. 4, the collected machining information is stored in the memory 22 in association with each of the plurality of machine tools 12. The step S1 may be carried out regularly and repeatedly, and the machining information stored in the memory 22 may also be updated each time the step S1 is carried out.

Subsequently, at step S2, the execution decision unit 24 decides whether it is time to execute sorting of the machine tools 12. The timing may be specified by an operator in advance. In this embodiment, it is assumed that the timing is specified to be “when an operator operates the input unit 30 to request sorting of the machine tools 12”. When the specified timing has not been reached, the process returns to step S1 and keeps regularly updating the machining information until an operator requests the sorting. When the specified timing is reached, the process moves to step S3.

At step S3, the grouping unit 28 sorts the plurality of machine tools 12 in such a way that machine tools 12 having like machining information belong to the same group. According to FIG. 4, the machine tool 12A and the machine tool 12C both have machining information “0001”. Also, the machine tool 12B, machine tool 12D, and machine tool 12E all have machining information “0002”. In this case, the grouping unit 28 sorts the machine tool 12A and the machine tool 12C into GROUP 1. Similarly, the grouping unit 28 sorts the machine tool 12B, machine tool 12D, and machine tool 12E into GROUP 2. The names and identifiers of the groups may be determined by an operator in an arbitrary manner.

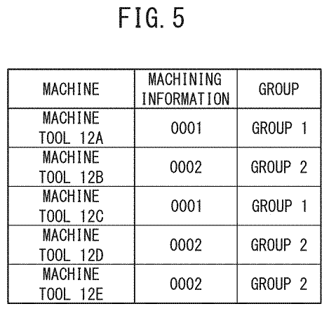

After the sorting operation finished, the grouping unit 28 generates the group information as shown in FIG. 5 and stores it into the memory 22. The grouping processing thus ends. According to the grouping device 10 of this embodiment, it is possible to easily achieve grouping of the plurality of machine tools 12 in such a way that machine tools 12 having a high correlation about machining operations are grouped together.

Settings of the plurality of machine tools 12 may be changed group by group. The operator can thus efficiently work without the need to change settings of the plurality of machine tools 12 separately. The operation of changing settings may be conducted through the input unit 30.

In this embodiment, the plurality of machine tools 12 are grouped such that machine tools 12 operating with the same machining program are grouped together. Accordingly, when each program is adapted to produce a certain product item, for example, the operator can easily grasp the number of products of each item manufactured within a day in the factory, by aggregate data concerning the number of products manufactured by each group. Further, the number of products manufactured within a day in the factory can be easily set item by item by changing the settings group by group as described above.

Even if the grouping device 10 can access the machine tools 12 (or can collect the machining information) only while the machine tools 12 are on, the grouping device 10 can generate the group information as long as the machining information is stored in the memory 22 at the point of specified timing. Therefore, according to the grouping device 10, the operator can manage operations for example by generating the group information for the next work day during hours of non-operation when the machine tools 12 are not working, while avoiding changing the group information within operating hours of the factory, for example.

### [Modifications]

The embodiment has been described as an example of the present invention and it is of course possible to modify or improve the embodiment in various ways. It is clear from recitation of claims that such modified or improved embodiments are also included in the technical scope of the present invention.

### (First Modification)

The execution decision unit 24 may be configured to decide to execute the sorting of the machine tools 12 according to other timing than when requested by an operator. For example, the execution decision unit 24 may be configured to decide to execute the sorting of the machine tools 12 at a time when any of the plurality of machine tools 12 is turned on. In this case, the grouping unit 28 may update the group information each time any of the plurality of machine tools 12 is turned on.

Alternatively, the execution decision unit 24 may be configured to decide to execute the sorting of the machine tools 12 when machine tools 12 actually start machining operation, or when a new machining program is inputted in control devices 18, for example. In this way, the basis on which the execution decision unit 24 makes the decision may be changed appropriately.

### (Second Modification)

The execution decision unit 24 may be configured to decide to execute the sorting of the machine tools 12 regularly. For example, the execution decision unit 24 may decide to execute the sorting of the machine tools 12 when a certain period (e.g., 24 hours) has passed. Then, the group information is regularly updated without requiring an operator to repeat the same operation regularly.

### (Third Modification)

The information collecting unit 26 may be configured to collect the machining information not regularly but when any machine tool 12 is turned on or at a timing requested by an operator. For example, the machining information may be collected when the machine tools 12 are turned on, and the machine tools 12 may be sorted at a timing requested by an operator.

### (Fourth Modification)

A plurality of machining programs may be stored in each machine tool 12 in such a manner that they can be switched when necessary. In such a case, the information collecting unit 26 may be configured to collect information only about a machining program that was most recently executed at each of the plurality of machine tools 12. Alternatively, the information collecting unit 26 may be configured to collect information only about a machining program specified by an operator.

### (Fifth Modification)

When a plurality of machining programs are stored in each machine tool 12, the information collecting unit 26 may collect the number of times that each machining program was executed, or execution time of each machining program, as the machining information. The grouping unit 28 may find which machining program was executed a largest number of times or for a longest time within a given period, for each of the plurality of machine tools 12. Further, the grouping unit 28 may sort the plurality of machine tools 12 based on the machining programs thus found. The given period here is not particularly limited but may be the latest one month, for example.

Each of the plurality of machine tools 12 may have uneven past machining records (the number of executions and the execution time of each machining program) for example because of some reason in the way they are practically operated in the factory. According to this modification, it is possible to sort the machine tools 12 in such a manner that machine tools 12 having a high correlation about past machining records are grouped together.

### (Sixth Modification)

The information collecting unit 26 of the embodiment collects identification information (program numbers) associated with the machining programs from the plurality of machine tools 12. The information collecting unit 26 may be configured to collect source codes of the machining programs from each of the plurality of machine tools 12, for example. Further, the grouping unit 28 may be configured to sort the plurality of machine tools 12 by comparing the entire source codes.

### (Seventh Modification)

The information collecting unit 26 may be configured to collect, as the machining information, a plurality of parameters indicting machining conditions from each of the plurality of machine tools 12. The grouping unit 28 may be configured to calculate the degrees of similarity from the plurality of parameters set for each of the plurality of machine tools 12 and sort the plurality of machine tools 12 into a plurality of groups based on the calculated degrees of similarity.

The degrees of similarity are calculated according to Expression 1 shown below, for example. In Expression (1), S_{AB} is the degree of similarity between the machine tool 12A and the machine tool 12B, P_{Ai} is a particular parameter set at the machine tool 12A, and P_{Bi} is a particular parameter of the machine tool 12B concerning the same item as P_{Ai}. The letter “i” (i=1 . . . I) is an identification number of a parameter item that is used for convenience in calculation. “Ci” is a weighting coefficient determined for each parameter identified with “i”. Specific values of I and Cᵢ may be determined by an operator in an appropriate way. Also, which parameter item is to be used to calculate the degree of similarity may also be determined by an operator in an appropriate way. Expression 1 is used in order to calculate the degree of similarity S_{AB} between the machine tool 12A and the machine tool 12B as mentioned above, but it may also be applied to calculate the degrees of similarity about the machine tools 12C, 12D, 12E.

$${S}_{AB} = \frac{1000}{1 + {\sum }_{i = 1}^{1} {{C}_{i} ( {P}_{Ai} - {P}_{Bi} )}^{2}} \qquad ( 1 )$$

The grouping unit 28 of this modification calculates the degree of similarity for each of all target machine tools 12 by using Expression 1 above and sorts the machine tools 12 based on the degrees of similarity calculated. The sorting may be performed based on whether the degree of similarity exceeds a threshold, for example. The setting of the threshold may be determined by an operator in an appropriate manner.

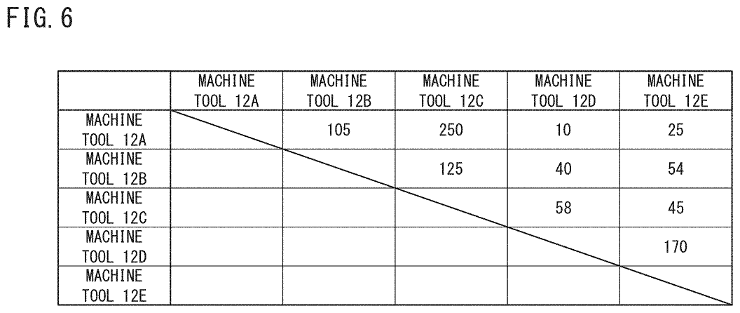

FIG. 6 shows an example of a correspondence table concerning the degrees of similarity generated by the grouping unit 28 of a seventh modification.

For example, suppose that the degrees of similarity between the plurality of machine tools 12 calculated by the grouping unit 28 are as shown in FIG. 6. It is also assumed that the threshold is 100. According to FIG. 6, the degree of similarity S_{AB} between the machine tool 12A and the machine tool 12B is 105, the degree of similarity S_{AC} between the machine tool 12A and the machine tool 12C is 250, and the degree of similarity S_{BC} between the machine tool 12B and the machine tool 12C is 125; all of them exceed the threshold 100. In this case, the grouping unit 28 sorts the machine tool 12A, machine tool 12B, and machine tool 12C into the same group. The grouping unit 28 further sorts the remaining machine tool 12D and machine tool 12E in the same way. Machine tools 12 having a high correlation about machining conditions are thus grouped together.

### (Eighth Modification)

The input unit 30 may be provided not only in the grouping device 10, but also in each of the plurality of machine tools 12. In this case, when an execution of the grouping processing is requested through any of the input units 30, the grouping processing may be executed for a plurality of machine tools 12 connected through the network 14. Also, when some setting of a machine tool 12 is changed from the corresponding input unit 30, the same change may be applied, based on the group information, also to other machine tool(s) 12 belonging to the same group as the machine tool 12 for which the setting has been changed. This improves efficiency of the operation of changing machining programs and parameter settings of a plurality of machine tools 12 that have a high correlation about machining operations.

### (Ninth Modification)

The grouping device 10 can be one of the control devices 18 of the plurality of machine tools 12. For example, the control device 18A may include the execution decision unit 24, information collecting unit 26, and grouping unit 28. This eliminates the need to provide a device for the grouping processing separately from the machine tools 12.

### Invention Obtained from Embodiment

The invention that can be obtained from the embodiment and modifications above will be recited below.

### <First Invention>

According to a first invention, the machine tool grouping device (10) includes: an information collecting unit (26) configured to collect machining information about machining operations from a plurality of machine tools (12); and a grouping unit (28) configured to sort the plurality of machine tools (12) into a plurality of groups based on the collected multiple pieces of machining information.

It is thus possible to easily achieve grouping of the plurality of machine tools (12) in such a way that machine tools (12) having a high correlation about the machining operations are grouped together.

Each of the plurality of machine tools (12) may have stored therein a machining program and identification information for identifying the machining program, and the information collecting unit (26) may be configured to collect the machining program or the identification information as the machining information from the plurality of machine tools (12). It is thus possible to sort the plurality of machine tools (12) in such a way that machine tools (12) having a high correlation about the machining programs are grouped together.

Each of the plurality of machine tools (12) may have stored therein a plurality of machining programs, each of the plurality of machine tools (12) may perform the machining operations by executing the machining programs stored therein, the information collecting unit (26) may be configured to collect execution records of the machining programs as the machining information, and the grouping unit (28) may be configured to find and identify, for each of the plurality of machine tools (12), one of the machining programs whose number of executions or execution time within a given period is largest, based on the execution records collected from the plurality of machine tools (12), and sort the plurality of machine tools (12) into the plurality of groups based on the machining programs thus identified. It is thus possible to sort the plurality of machine tools (12) in such a way that machine tools (12) having a high correlation about the past machining records are grouped together.

Each of the plurality of machine tools (12) may have set therein a plurality of parameters indicating machining conditions, the information collecting unit (26) may be configured to collect the plurality of parameters as the machining information, and the grouping unit (28) may be configured to calculate degrees of similarity from the plurality of parameters set for each of the plurality of machine tools (12) and sort the plurality of machine tools (12) into the plurality of groups based on the calculated degrees of similarity. It is thus possible to sort the plurality of machine tools (12) in such a way that machine tools (12) having a high correlation about the machining conditions are grouped together.

The information collecting unit (26) and the grouping unit (28) may execute respective processing according to a specified timing. Thus, the grouping processing can be performed as needed, for example according to an appropriate timing requested by an operator.

The information collecting unit (26) and the grouping unit (28) may execute respective processing regularly and repeatedly. Thus, the group information can be updated regularly, for example, without requiring the operator to regularly repeat the same operation.

### <Second Invention>

According to a second invention, a machine tool grouping method includes: an information collecting step of collecting machining information about machining operations from a plurality of machine tools (12); and a grouping step of sorting the plurality of machine tools (12) into a plurality of groups based on the collected multiple pieces of machining information.

It is thus possible to easily achieve grouping of the plurality of machine tools (12) in such a way that machine tools (12) having a high correlation about the machining operations are grouped together.

Each of the plurality of machine tools (12) may have stored therein a machining program and identification information for identifying the machining program, and the information collecting step may collect the machining program or the identification information as the machining information from the plurality of machine tools (12). It is thus possible to sort the plurality of machine tools (12) in such a way that machine tools (12) having a high correlation about the machining programs are grouped together.

Each of the plurality of machine tools (12) may have stored therein a plurality of machining programs, each of the plurality of machine tools (12) may perform the machining operations by executing the machining programs stored therein, the information collecting step may collect execution records of the machining programs as the machining information, and the grouping step may find and identify, for each of the plurality of machine tools (12), one of the machining programs whose number of executions or execution time within a given period is largest, based on the execution records collected from the plurality of machine tools (12), and sort the plurality of machine tools (12) into the plurality of groups based on the machining programs thus identified. It is thus possible to sort the plurality of machine tools (12) in such a way that machine tools (12) having a high correlation about the past machining records are grouped together.

Each of the plurality of machine tools (12) may have set therein a plurality of parameters indicating machining conditions, the information collecting step may collect the plurality of parameters as the machining information, and the grouping step may calculate degrees of similarity from the plurality of parameters set for each of the plurality of machine tools (12) and sort the plurality of machine tools (12) into the plurality of groups based on the calculated degrees of similarity. It is thus possible to sort the plurality of machine tools (12) in such a way that machine tools (12) having a high correlation about the machining conditions are grouped together.

The information collecting step and the grouping step may be executed according to a specified timing. Thus, the grouping processing can be performed as needed, for example according to an appropriate timing requested by an operator.

The information collecting step and the grouping step may be executed regularly and repeatedly. Thus, the group information can be updated regularly, for example.

What is claimed is:

1. A machine tool grouping device comprising:
an information collecting unit configured to collect machining information about machining operations from a plurality of machine tools; and
a grouping unit configured to sort the plurality of machine tools into a plurality of groups based on multiple pieces of the collected machining information.

2. The machine tool grouping device according to claim 1,
wherein each of the plurality of machine tools has stored therein a machining program and identification information for identifying the machining program, and
the information collecting unit is configured to collect the machining program or the identification information as the machining information from the plurality of machine tools.

3. The machine tool grouping device according to claim 1,
wherein each of the plurality of machine tools has stored therein a plurality of machining programs,
each of the plurality of machine tools performs the machining operations by executing the machining programs stored therein,
the information collecting unit is configured to collect execution records of the machining programs as the machining information, and
the grouping unit is configured to find and identify, for each of the plurality of machine tools, one of the machining programs whose number of executions or execution time within a given period is largest, based on the execution records collected from the plurality of machine tools, and sort the plurality of machine tools into the plurality of groups based on the machining programs thus identified.

4. The machine tool grouping device according to claim 1, wherein
each of the plurality of machine tools has set therein a plurality of parameters indicating machining conditions,
the information collecting unit is configured to collect the plurality of parameters as the machining information, and
the grouping unit is configured to calculate degrees of similarity from the plurality of parameters set for each of the plurality of machine tools and sort the plurality of machine tools into the plurality of groups based on the calculated degrees of similarity.

5. The machine tool grouping device according to claim 1, wherein the information collecting unit and the grouping unit execute respective processing according to a specified timing.

6. The machine tool grouping device according to claim 1, wherein the information collecting unit and the grouping unit execute respective processing regularly and repeatedly.

7. A machine tool grouping method comprising:
an information collecting step of collecting machining information about machining operations from a plurality of machine tools; and
a grouping step of sorting the plurality of machine tools into a plurality of groups based on multiple pieces of the collected machining information.

8. The machine tool grouping method according to claim 7,
wherein each of the plurality of machine tools has stored therein a machining program and identification information for identifying the machining program, and
the information collecting step collects the machining program or the identification information as the machining information from the plurality of machine tools.

9. The machine tool grouping method according to claim 7,
wherein each of the plurality of machine tools has stored therein a plurality of machining programs,
each of the plurality of machine tools performs the machining operations by executing the machining programs stored therein,
the information collecting step collects execution records of the machining programs as the machining information, and
the grouping step finds and identifies, for each of the plurality of machine tools, one of the machining programs whose number of executions or execution time within a given period is largest, based on the execution records collected from the plurality of machine tools, and sorts the plurality of machine tools into the plurality of groups based on the machining programs thus identified.

10. The machine tool grouping method according to claim 7, wherein
each of the plurality of machine tools has set therein a plurality of parameters indicating machining conditions,
the information collecting step collects the plurality of parameters as the machining information, and
the grouping step calculates degrees of similarity from the plurality of parameters set for each of the plurality of machine tools and sorts the plurality of machine tools into the plurality of groups based on the calculated degrees of similarity.

11. The machine tool grouping method according to claim 7, wherein the information collecting step and the grouping step are executed according to a specified timing.

12. The machine tool grouping method according to claim 7, wherein the information collecting step and the grouping step are executed regularly and repeatedly.
